(19) United States
(12) Patent Application Publication
(10) Pub. No.: US 2014/0282188 A1
(43) Pub. Date: Sep. 18, 2014

(54) COMPUTER GRAPHICAL USER INTERFACE, SYSTEM, AND METHOD

(71) Applicant: MORESTEAM DEVELOPMENT LLC, Powell, OH (US)

(72) Inventors: William M. Hathaway, Powell, OH (US); Lars Maaseidvaag, Venice, FL (US); Smita Kulkarni Skrivanek, Indianapolis, IN (US); Maurice Klaus, Novi, MI (US); Alan Gao, Columbus, OH (US); Caleb Hearon, Columbus, OH (US); Brian C. McDaniel, Hilliard, OH (US)

(73) Assignee: MORESTEAM DEVELOPMENT LLC, Powell, OH (US)

(21) Appl. No.: 13/843,486

(22) Filed: Mar. 15, 2013

(51) Int. Cl. G06F 3/0482

(52) U.S. Cl. CPC G06F 3/0482
USPC 715/771

(57) ABSTRACT

A computing system is disclosed having one or more processors, a display, and a memory coupled to the one or more processors. In this computing system, the memory stores program instructions executable by the one or more processors to display a graphical user interface on the display. The graphical user interface includes at least one user interface data object associated with a stored data set and displaying visual attributes corresponding to properties of the data set, including an attribute corresponding to data type.

### FIELD

The present disclosure relates generally to a computer-human user interface for a software application, and systems and methods of implementing same. The disclosure also relates to a system, method, and computing environment for data analysis, and\or for a data analysis software application, program, or portion or module thereof. The disclosure relates further to a user interface and method that includes or incorporates object-oriented elements and/or steps, particularly in interfacing a user with a data analysis software application.

### BACKGROUND

The user interface of software and computer programs usually refers to the graphical and auditory information presented to the user on a display, and the control sequences the user employs to control the program and progress through a session. A user interface for electronic mail applications allows the user to send, receive, respond to and organize mail and related information. In simple spreadsheet applications, the user interface allows the user to enter, manipulate, and organize data. It also allows the user to create new data and/or employ mathematical tools to further analyze, organize, derive, and display data. These applications have traditionally employed menu-heavy interfaces, with which the user positions a control pointer over tabs, tiles, or texts that are descriptive of a function or data of the application. Pull-down menus and pop-up windows usually accompany selections and present different selection or task options to the user. For such straight-forward software applications, where the user only has to learn a few commands or run a few repetitive tasks to make effective use of the program, the traditional menu-heavy user interface serves its purpose. The benefit inherit in the user's familiarity with the software application and its existing user interface outweighs the efficiency and ease that may be gained from the introduction of a new and improved interface. The new interface would still have to be learned by the user, and the tasks required of the old interface may simply not be that difficult or time consuming.

On the other hand, software applications that provide data analysis and display functionalities can become difficult and cumbersome to use, especially if multiple analytical tasks are required on vast amounts of data or data types. Furthermore, some software applications provide support for larger, on-going projects that may require data analyses at different stages of projects, for different projects, and different tasks. Providing support for such projects, the software application may be required to provide an array of data analytical tools and to access and store different types of data at different times and points of a project. For example, a user engaged in a quality improvement process may benefit from data analysis at different points in a process improvement cycle. A data analytical software application such as Engine Room®, which is a proprietary application by MoreSteam.Com LLC of Ohio, supports the user by offering an array of such data analytical tools, and organizing the tools according to the stages of the process improvement effort. Such software applications must also receive and store data and data files which may be the subject of the data analysis tasks. Despite efforts to organize the data and the tools available to the user, it is not uncommon for the user to spend time not only searching for appropriate tools, but searching and selecting data to match the tools.

Accordingly, there is a need for an improved user interface, and computer system for data analysis software applications, and methods of implementing same.

### SUMMARY

Disclosed is a computer-implemented method of initiating a data analysis function on a graphical user interface of a computer display. The method includes presenting a graphical user interface on a computer display of a computing apparatus having a controller, where the graphical user interface contains a plurality of graphical objects controllable by the controller, including a tool object associated with a data analysis function and a data object selection region containing at least one data object associated with at least one stored data set. A tool object is selected (i.e., by the user or responsive to a request by a user) to establish a corresponding study object on the user interface. The at least one data object associated with the at least one stored data set is then enabled and the study object is engaged with the at least one data object on the user interface to initiate the data analysis function, whereby the at least one stored data set are input variables to the data analysis function and a graphical element (e.g., a chart or graphical representation) is displayed on the user interface as output to the initiated data analysis function.

A computing system is also disclosed having one or more processors, a display, and a memory coupled to the one or more processors. In this computing system, the memory stores program instructions executable by the one or more processors to display a graphical user interface on the display. The graphical user interface includes a data object selection region containing at least one user interface data object associated with a stored data set and displaying visual attributes corresponding to properties of the data set, including an attribute corresponding to data type. Preferably, the visual attributes include a first reflective of data type and a second containing a graphical display derived from the associated data set. For example, the data object may include a window having a histogram of the data set.

In another aspect, a non-transitory computer-accessible storage medium is provided. The medium stores program instructions computer-executable to implement a graphical user interface for presentation on a computer display. The graphical user interface includes at least one user interface data object associated with a stored data set, the at least one data object displaying visual attributes corresponding to properties of the data set. Further, the at least one data object is movable from the data object selection region to an analysis region to initiate input of the data set into a data analysis function.

### BRIEF DESCRIPTION OF THE DRAWINGS

FIGS. 1A-1C are a simplified illustrations of a spreadsheet application-based user interface in the prior art;

FIG. 2 is a simplified block diagram of computing architecture suitable for use with exemplary embodiments;

FIGS. 3A-3B are simplified illustrations of basic elements of an exemplary computing system and method of data analysis according to embodiments;

FIGS. 3C-3D are simplified illustrations of user interface elements and techniques employed by certain embodiments;

FIG. 4 is a simplified process diagram of a method of data analysis according to an embodiment of the disclosure;

FIGS. 5A-5D depict exemplary computer-user user interface environments according to certain embodiments;

FIGS. 6A-6G depict exemplary computer-user interface environments according to certain embodiments; and

FIGS. 7A-7F depict exemplary computer-user interface environments according to certain embodiments.

### DETAILED DESCRIPTION

The systems, methods, and user interfaces described are particularly suited for use or operation with a data analysis software application. A system presenting or containing such a software application may include data storage and access capabilities, analytical tool functionalities, and display facilities. The system may also benefit from a depository for storing and accessing historical results of data analysis.

As used herein, the term “data analysis” means the execution of a computer program or algorithm to access a target collection of data or information (“data source’) and to evaluate, manipulate, or organize the target data, so as to derive or extract useful information from the data and present the useful information in a form or format different from the original target collection. The presentation of the new information embodies the “results” of the data analysis, and may be conveyed through charts, graphs, and\or textual write-ups, all of which are considered “output.” Moreover, as used herein, the term “Study” or “Studies”, as it relates to “data analysis”, refers to the means by which or the tool(s) used to perform the data analysis, including the parameters of the analysis, the target data that is the subject of analysis. A “study” preferably includes output of the data analysis and/or user-added information associated with the study.

Also, as used herein the term “data analysis tool” refers to a computer-executable program or functionality for performing “data analysis” using target data as input. In the present descriptions of systems and user interfaces, the “tool” will be presented in a computing environment readily accessible to the user. For purposes of this disclosure, the term “data analysis function” means a computer program, tool, or other facility having the capability or the means to perform “data analysis” on target data. In a preferred environment, a tools library includes or provides access to an integrated suite of software facilities for data manipulation, calculations and graphics (“data analysis facilities”).

In one aspect of the present disclosure, a computer-user interface (and systems and methods) is provided that promotes the user's focus and actions on business or analytical task processes rather than computer-oriented issues such as running and navigating software applications and searching and storing files. The user interface, systems, and methods are particularly suited for implementation with software applications featuring data analyses, manipulation, and display. The disclosure introduces improvements to such user interfaces, and a system and method of data analysis, manipulation, and\or display via a computer display and interface, that focus less on the software tools and data locations and more on the mathematical attributes of the data, analyses on the data, and display of data and analytical results pertinent to the greater objectives of the user and/or further users. Accordingly, the improved user interface, and associated systems and methods, introduced herein may be described as taking a more object-oriented approach to computer-implemented methods of analysis and user interfaces, rather than an applications-oriented approach.

FIG. 1 depicts a user interface 110 for a prior art data analysis software application that may serve as background information for the present disclosure. An appreciation and understanding of the present disclosure's particular contribution to the art may be gained with reference to methods and functions associated with this type of data analysis software application. The user interface 110 depicted reflects features of a proprietary desktop-based application called Engine Room® data analysis software available from MoreSteam.com LLC in Ohio. The software is available as an add-in to a Microsoft Excel® platform. This software application is designed to support users implementing the quality improvement process termed DMAIC, which is a data-driven improvement cycle used to improve, optimize, and stabilize business processes and designs. With this application, a spreadsheet or worksheet provides a platform on which data are stored, edited, and arranged. As the application is intended to support a quality improvement process, the user interface 110 is particularly directed to user implementation of certain fundamental problem-solving tools commonly used to support process improvement efforts. As generally known, the worksheet 112 arranges data in rows and columns that define spreadsheet cells, and users may be given various options for interacting with and editing the data. New data are entered by highlighting a cell and typing into a window that appears above the spreadsheet. Also, the user may globally replace data, make computations on the data, or perform a number of functions.

As shown in FIG. 1A, the user interface 110 may be divided into three parts or regions: a menu bar 114 along the top margin of the user interface 110, a ribbon bar 116 below the menu bar 114, and the worksheet 112 below the ribbon bar 116. The menu bar 114 contains several text-based buttons which allow the user to navigate the application and interface with the Microsoft Excel® spreadsheet. When the add-in data analysis program is enabled, the ribbon bar 116 appears below the menu bar 114 and presents the data analysis tools available by way of pull-down menus 118.

FIGS. 1A through 1C provide snapshots of at least three of the various stages (and states of the user interface 112) navigated by a user to perform an analytical process on data stored on the worksheet 112. In this example, the user performs a pareto analysis using two sets of related data: (a) types of medication error and (b) frequency of error. As shown in FIGS. 1A and 1B, this data appears on the worksheet 112 while the user navigates the spreadsheet menus to find the pareto analysis function and apply it to the data. Parts of the worksheet 112 are often obscured, however, by menus or windows activated by the user. For example, the user must enable the appropriate tab in the ribbon bar 116 to reveal a pull-down menu 118. The user then finds and enables the pareto analysis tool in the menu 118, thereby opening a new data selection window 122 for preparing the pareto analysis. See FIG. 1B. Another window 124 inside the data selection window 122 lists the data sets in the worksheet 112 by name and type. The user scrolls through the list and finds the data set “Medication Error” among the eleven other data sets on the list, as it is aptly named and selects it for analysis. The user also highlights the data set “Frequency” which he thinks corresponds to the “Medication Error” data set. If the user is correct in his selection of data variables, the pareto chart 128 in FIG. 1C is created and appears in a new window 130 over the worksheet 112.

The present disclosure provides general and specific improvements and enhancements to the system and methods associated with data analysis software applications of the type described above and in respect to FIGS. 1A-1C. These improved and enhanced systems and methods are well suited for the computing architecture and system 210 depicted in FIG. 2. Specifically, the systems and methods are preferably implemented with a web-based system architecture that takes advantage of one or more networks 212 having one or more servers 214 and one or more client stations 216. The system 210 may also include a dedicated database server 218 for storing and manipulating client data and a dedicated server 220 for programs responsible for analytical processes and support. The data and program logic and functionalities of the software application may be shared among the various client stations and server devices in real time. Accordingly, the system may be described as employing cloud computing capabilities to perform or support the data manipulation and computation required by these software applications.

Preferably, details of the configuration and dynamic processes of the system 210 will not be apparent to the user at the client station 216. The web-based software application may execute and launch in a web browser on the user's client station 216, with minimal or no download and management of software modules. The user client station 216 preferably includes one or more processors 230 with memory to handle and share in the operating tasks of the software application, data storage or secondary memory, and a display 232 on which the user may interact with a graphical user interface for the software application. The user client station 216 also includes a control pointer for interacting with the user interface. Such a control pointer may be provided by a keyboard, a mouse, a touch-screen, a touch-pad, joystick, and other common devices, and various combinations of these devices. The client station in FIG. 2 is shown with a standard computer keyboard 234, but preferably will also include a mouse or other control device particularly adept at direct manipulation of objects on a graphical user interface.

It will become apparent to, and understood by, those skilled in the relevant art, that in alternative applications, the network 212 may be a local area network, a wide-area network, the Internet, or other suitable communications network. Additionally, the function of the client station 216 may be performed in these alternative applications by a mobile phone device, a tablet, a laptop, desktop, or other computing device (existing or future devices).

A data analysis software application and system according to the present disclosure may be described by the schematics of FIGS. 3A and 3B which represent the system's basic functionalities. Preferably, the user operates the client station 216 to implement the software application and to communicate with the system's various functionalities. The client station 216 may include one or more processors coupled to a system memory, and one or more input/output devices, including a cursor control device, keyboard, and display, (collectively referred to as “computing device”, “computing system”, or “computer apparatus”). Certain programs of the software application are loaded onto and reside in the computing device, and communicate with other programs and files through the web-based system 210. The client station 216 may also include a user interface module, a network-interface communication module, and additional data storage. To facilitate description, references to the software and its processes are usually made from the perspective of the user at the client station 216, without regard to the web-based system and the physical associations of dynamic processes, files, and programs.

A system model (system 350) embodying elements of the data analysis application and method includes a graphical user interface 310 accessible from computing device 216, a first collection or database of data appropriate as input for data analysis (Projects Database 312), a suite or library of data analysis tools (Tools Library 314), and preferably, a depository for analysis events or Studies 324 (Studies Database 316). The system 350 is configured such that the computing device 216 communicates with each of the Projects Database 312, the Tools Library 314, and Studies Database 316 through the Internet, as shown in FIG. 3A. Tabs 318 in the Tools Library 314 represent categories of Tools which are accessible by the user directly from the user interface 310. In the present software application context, the Tool (Tool function) is a callable unit of programmed instructions, procedures, routines or functions that may be initiated to perform data analysis (usually statistical analysis) on target data or file. The Tool or Tool function is accessible and deployable by the user via the graphical user interface 310. In one exemplary environment, the system and software application provides a tools interface to an integrated suite of software facilities for data manipulation, calculations, and graphical display (“data analysis”). More specifically, the tools interface connects the user to a separate “R” statistical environment on a server(s). As generally known, “R” is an open source software environment for statistical computing and graphics, available under a GNU general public license.

The Projects Database 312 in this case is merely a collection of discrete data sources each of which is commonly identified to and grouped by Project 322. Each Project is defined by parameters relevant to the user. For example, a Project may represent a quality improvement effort directed to a specific process in the user's organization. In this web-based system 350, computing device 216 generally extracts data from the Projects Database 312 and directs the data as input to a Tool function selected from the Tools Library 314. In exemplary embodiments, the selected Tool function will perform data analysis on the data and deliver an output to or through computing device 216. Computing device 216 may also deliver output to Studies Database 316 or some other external facility, such as a printer, data storage, or another client station. As shown in FIG. 3A, computing device 216 may receive data and information from the Tools Library 314 and from Studies Database 316.

It should be noted that data and information associated with a Project does not necessarily mean that the data and information physically reside in a single database. The Projects Database 312 in FIG. 3A simply represents and illustrates that, from a functional perspective, the collection of Projects or, more specifically, the collection of data sources, is logically arranged and accessible in the software (e.g., via the user interface 310). In most operating modes, a user typically deals with, and makes active, a specific Project in the Projects Database 312 (which is shown in shade in FIG. 3A). Thereafter, computing device 216 communicates specifically with Data Sources 320 identified to the active Project. This is illustrated in FIG. 3B, wherein Data Sources 320 identified to the active Project are arranged and displayed in a Data Source Database 322, and made accessible to computing device 216 and to the user via user interface 310.

For purposes of the present disclosure, a data source is understood to contain one or more sets of data or information just as a spreadsheet may contain specific collections of data arranged in rows under a column. The data identified to a set will be of a specific type or category, such as text or characters, time and date, and numeric information, and may be arranged in random or in a predetermined manner of importance. So, in summary, data and information are grouped together in data sets, data sets are grouped together by data source, and data sources are grouped together by Project.

In this embodiment, Study 324 refers to a stored computing event—the initiation of the Tool function to perform data analysis on target data. Thus, a Study 324 stored in Studies Database may include the Tool function selected and any relevant parameters, the target data, and the results or Output, user-associated data or information (including relevant conclusions), and time-stamped history. In certain embodiments, information in a Study will simply include reference to the Tool function and target data such that the Output may be readily reproduced by the original user or a new user. Output may include charts, graphs, tables, listing, and other arrangement or display of information resulting from the data analysis. The study may also include user-associated information such as notes, conclusions, or user information.

FIGS. 3A-3B reflect, therefore, the interrelation between the user and computing device 216 and the basic elements or objects that the user and computing device 216 manages. The elements include various levels or layers of data and tool functions, and studies. To facilitate management of these elements or layers, and the performance of data analyses, the present system 310 employs a particularly advantageous graphical user interface 310. In preferred embodiments, the user interface 310 utilizes user interface object elements to represent data elements, tool functions, and\or other system elements to facilitate a user's decision making process and management of these system elements. The user interface 310 may also employ such object elements to represent and convey action between elements, including the initiation of a Tool function to perform data analysis on a selected data set. This is sometimes referred to as the engagement of an object representing the Tool function with an object representing a selected data set (i.e., input data variables to the tool function). In addition, object elements used to represent data or tool functions are provided visual attributes that correspond with and thereby, convey properties of the underlying data or information. In the present computing environment, wherein the user has to consider layers of tool functions and layers of data, or even Studies, the objects assist the user in selection and decision making processes.

FIGS. 3C and 3D illustrate features of an exemplary user interface environment of the disclosure, and how the relationships of system elements in FIGS. 3A-3B are translated onto the user interface 310. Data Source Database 322 and Data Sources 320 from FIGS. 3A-3B are represented as user interface objects that the user can manipulate to translate the data among system elements and across the user interface environment, and to initiate action. In this example, Database 322 is represented by a user-activated container panel 332 while Data Sources 320 identified to the Database 322 are represented by icons 334. The Data Source icon 334 may be enabled to reveal yet another container panel—a data set panel 336. Each tile object 338 in panel 336 represent a data set of the data source 320 (e.g. a row of numbers in a worksheet that provides data source 320). In an important aspect, data set object 338 is provided with visually observable attributes that correspond to properties of the underlying data set. As shown in the example depicted in FIG. 3D, data set object 338 includes a hexagon icon 344 as well as text 342 revealing the name, data type, and count. As will be shown below, the hexagon icon 344 is itself a user interface object and may be moved about the user interface 330 to translate the underlying data set to another object or system function (e.g., a tool function). The hexagon icon 344 visually associates with the data source object 334 as well as a data variables field that is described below. As used herein, one hexagon icon or object is, in addition to being visually associated with another hexagon icon or hexagon, described as substantially corresponding or matching with another hexagon icon or object because of the visual similarity between the two (as opposed with other objects) and because one of the icons or objects can be moved into the other to initiate an action.

In a further aspect, the data set object 338 may be enabled to reveal summary analytical information and\or other properties of the data set. This is shown in FIG. 3C, where tile 338 is enabled by hovering a pointer about tile object 338 to reveal window 340. Window 340 may contain such summary or composed information as statistical data, charts, and tables reflecting properties of the data set. As used herein, the term summary or composed information or properties refer to information different from the data or information in the data set, but may be information or data derived from the data set. For example, summary analytical information may result from preliminary statistical operations performed on the data set, such as determining minimum and maximum values, means, average or standard deviation. For some data sets, a presentation of the data sets or information may also be provided, for example, in a list or table.

Thus, information on an underlying data set may be available upon visual review of data set object 338—without having to open or view underlying layers of data elements or the underlying data set. Additional and more detailed properties may also be obtained by activating the window 340. These properties may be previewed without the user having to select and initiate data analysis on the data set. These visual clues may be used, for example, to confirm a match of the data set for use as input for a particular tool function. Additionally, the properties provided in window 340 may also help the user determine the appropriateness of a tool function for the data set (e.g., the degree of data normality or the AD p-value). Use of these clues may prevent confusion and time wasted testing data sets that are incompatible with selected tools or, because of their properties, are not likely to produce information useful to the process improvement effort.

Referring back to FIG. 3A, the system 350 provides a library 314 of data analysis tools for the user. The tools are arranged and categorized in a manner convenient to the user, but more significantly, and in furtherance of the object-oriented approach, in an arrangement pertinent to the subject, event, or circumstance relevant to the user task. In the example, the software application is provided as support for a quality improvement process, where the results of data analysis are intended to guide the user through various stages of the improvement effort. The improvement process is characterized by five stages: Define, Measure, Analyze, Improve, and Control. The tabs of a menu bar are defined literally by these stages of the process, rather than the tools themselves. The tools remain hidden in pull-down menus associated with each stage. In this way, the user's perspective remains on the real-world tasks and not on the mechanics of the system and software applications. With knowledge of the Project, the user is typically aware which stage of the process is pertinent, and thus, which tab along the menu bar is likely to provide useful or target tools in a pull-down menu. In some instances, the user may be led to a particular stage or to search for certain types of tools, and selects a tool after considering the array of tools presented.

A user selects a tool from a pull-down tool menu to perform data analysis relevant to the active project and also selects the data set(s) that will serve as input to the tool. This exercise of the tool on the selected data sets, as well as the results of the tool implementation, are identified to a Study, and then stored in Studies Database 316. The properties of the Studies accessible from the Studies Database 316 include information on the tool function implemented, input to the tool (e.g., data sets) and other parameters, user-added information, and the results or output of the analysis, which may comprise of charts, new data, and newly generated data and information. As will be illustrated below, an object in the Studies Database 316 may be enabled to reveal another object reflecting the underlying Study.

FIG. 4 illustrates an exemplary method of performing data analysis and/or generating a project study according to the present disclosure. The method chosen for illustration is one that utilizes the various system elements identified in FIGS. 2 and 3 by way of a graphical user interface and from the perspective of the user at a client station. The method may be initiated by the user selecting a tool function (408), which in actuality entails the user enabling a tool object on the user interface. In some embodiments described, the user interface requires the user to first select a Project phase, which in turn, reveals a pull-down menu of tool functions relevant to the project phase. The user enables a tool object from the pull-down menu by highlighting, double clicking, and/or dragging the tool function object to a workspace of the user interface. In one aspect, the tool selection also establishes a study object in the workspace, which provides the user with certain properties required of the data variable(s) (which are input to the tool function). The study object in this case is a “dynamic” object that evolves and captures additional information as the user progresses through tasks and projects.

In this embodiment, the user enables a Project (410). A list of established projects may be presented to the user, in which case the user selects and enables one of the projects. Alternatively, the user enables a new project which entails uploading one or more new data sources and naming the new project. In either case, by enabling a project, one or more data source options are presented to the user, preferably, as data source objects in a data sources election region on the user interface.

After considering the data source options, the user enables (and selects) a data source object (412). This initiates presentation of data set objects (in a data set selection region) that represent underlying data sets identified to the enabled data source. In a unique aspect, the data set objects have visual attributes that correspond to properties of the underlying data sets. For example, the data set objects may incorporate descriptive icons with both text and figures that signify properties of the underlying data sets. The user can, therefore, consider the underlying data set for use by reviewing the data set objects and the properties indicated for the data set (414) and in further view, of the properties of data variable(s) set forth for the selected tool. In further embodiments, to review additional properties of the data set, the user may enable any data set object to reveal a window containing additional properties. As discussed above, the additional properties may be analytical information derived from the data set, as well as a presentation of the actual data or information in the data set.

With information on the properties of the underlying data set, the user's decision to select the data set for analysis (or a tool function to initiate) is made easier. Either way, the user may consider viewing (or evaluating) another data set object (416). If the user decides against using the data set, the user simply discards the data set, moves the pointer to another data set object, and reviews the properties of its underlying data set (414). If, on the other hand, the user selects the data set, the user can move the data object into the workspace and toward the study object. To implement the selected tool function with the selected data set as input, the user engages the selected data set object(s) with the active study object (418). This is managed by simply dragging the data set object(s) into the workspace and attaching it to the active study object, which automatically initiates the tool function. In further embodiments, the study object will also have visual attributes providing clues as to where the selected data object should be positioned. Visual attributes of the study object may also indicate if additional data sets are required, in which case tool implementation is incomplete. The user can go back to the presentation of data set objects (e.g., data set panel) to review and enable additional data set candidates.

When the study object has engaged all required data set objects, the tool function is initiated and the output is displayed. The user can review the output on the user interface, and if not satisfied, modify the study by adding, deleting, and\or substituting data set objects. In any case, the study object is automatically updated, including the output associated with the study object. By closing the study object, it is automatically saved in the Studies Panel (420). The study object (and study) may also be saved by closing the study object at any time after tool function selection.

In accordance with the present disclosure, the methods of data analysis an\or presentation described herein, and related methods, including the operation of one or more segments of a data analysis software application may be improved and enhanced by employing a system and a computer-user interface as will now be described with reference to FIG. 5.

Exemplary Graphical User Interface(s) and Method of Implementing Same

FIG. 5A depicts a computer display 510 and a graphical user interface 512 presented thereon, which are suitable for the data analysis software application and for implementing steps and methods previously described in respect to FIGS. 3-4. As with most computer user interfaces, the user interface 512 of this software application may be navigated, engaged, and changed through use of a keyboard and control pointer such as a mouse, cursor, or equal (not shown). These control devices are specifically used to manipulate a plurality of graphical user interface elements or widgets. In one aspect of the disclosure, the user interface 512 preferably employs several types of widgets to facilitate the user's management of projects and data sources and selection and employment of an array of data analysis tools. These widgets include menus, toolbars, containers such as windows, panels, and palettes, icons, buttons, and other common user interface elements. The present graphical user interface favors an object-oriented design (i.e., as opposed to an application-oriented design), whereby the user interacts explicitly with objects that are intuitive representations of the entities in the domain relevant to the application. In the embodiments described herein, these user interface objects may represent projects, data sources or data sheets, data sets, tools and tool functions, and studies, among other things. In one enhancement of the prior art, the user interface employs icon views (or simply, icons) as an object element and to represent instances of an object, but also to signify certain properties or attributes of the entity represented by the object. In further embodiments, the user interface employs combinations of icons, property views and composed views in an object to inform and aid the user in selecting an object among other like objects.

The interactive user interface 512 includes a canvas on which a workspace 514 is preferably centered for convenient access by the user. In this embodiment, a horizontal Task Menu 516 is positioned along the upper margin above the workspace 514. The Task Menu 516 comprises several tabs 518 each distinctly representing a working or project phase of the DMAIC quality improvement process. The data analyses tools available to the user are allocated among the project phase tabs 518, with tools being assigned to the project phase(s) under which it is commonly associated or used. Clicking on a tab activates a pull-down Tools Menu 520 that presents a sub-array of the tools commonly used in that phase. In this embodiment, the system provides an interface with a suite of statistical and graphics display facilities in the “R” environment (under an open source license). Table 1 below provides a sampling of common data analyses tools that are integrated into the exemplary software application and which are particularly suitable for use with presently described systems, methods, and user interfaces.

TABLE 1
Sample of Data Analysis Tools and Functions

| | |
|---|---|
| Histogram | Trend Chart |
| Box Plot | Pareto Analysis |
| Histogram | Scatter Plot |
| Simple Regression | X Bar and R/S Chart |
| Anderson Darling | Arc Sine Transformation |
| Log Transformation | Hypothesis Testing |

The user interface 512 is further equipped with a container panel called the Projects Panel 524 to the left of the workspace 514 (a project selection region of the user interface 512). The Projects Panel 524 contains one or more objects 532 each representing a Project. As described previously, the Project refers to a collection of data sources, and in some embodiments, a collection of Studies. The object 532 used in this interface includes a gear icon and text that is descriptive of the Project. When a new project is indicated, data for the project may be uploaded as one or more data source files from an external spreadsheet (for example). For each data source file uploaded, a data source object 528 representing the data source file appears in another container panel or Data Sources Panel 526 (a Data Source selection region), as shown in FIG. 5B. Creating a new project also establishes a corresponding Studies Panel 522 to the right of the workspace 514 (a studies selection region). As alluded to earlier and further explained below, the Studies Panel 522 houses the elements of a data analyses event or Studies (i.e., wherein a data analysis tool is implemented and generates analytical results). By dragging and dropping a data source object 528 into the workspace 514, the underlying file—the worksheet 544—appears, displaying data stored in the worksheet. As with traditional worksheets, the user can interact with the worksheet and may edit its cell contents or its titles. For existing projects, editing the contents of a data source may result in changes to Studies that used data from the data source.

The user interface 512 in FIG. 5C is shown in an early or initial mode of operation under a selected Project. In respect to the process illustrated in FIG. 4, the user interface status in FIG. 5C may be presented to the user during the step of “enabling a data source object to initiate presentation of data sets objects.” In this description, the term “enabling” means to prompt, signal, or activate a user interface element by clicking on, highlighting, hovering about, or otherwise changing the status of the element and initiating a response from the user interface 512. The Data Sources Panel 526 displays a plurality of data source objects 528 each representing a data source identified to “Project X”, one of which is highlighted to indicate being enabled. A project button 530 located along the bottom margin of the Data Sources Panel 526 is operable to shift or transform the container panel 526 between two views or modes. In the mode depicted in FIG. 5C, the container panel 526 is identified to a specific project and contains the data sources of the project. In a second view or mode initiated by clicking the project button 530, the container panel 526 houses the various Projects pertinent to the user. In this second view, an array of Projects is displayed in the Panel, including Project X. See e.g., FIG. 5A. When Project X is enabled by a single mouse click, for example, the panel rotates or transforms to the panel view in FIG. 5C, which is specific to Project X and displays data source objects 528 identified to Project X.

In this exemplary user interface 512, each data source object 528 is presented as an icon featuring multiply stacked and offset hexagons. The stack is accompanied with text associated with the data source, including the data source name. The reference to multiple hexagons corresponds to the data sets contained in the data source, which are represented individually by a hexagon icon. Thus, the display of multiple hexagons may suggest to the user that the object refers to multiple data sets.

In one aspect of the disclosure, the user enables a data source object 528 (within the Data Source Panel 526) to reveal properties of the underlying data source file. The properties are conveyed in one view and without reproducing the contents of the data source file. A container sub-panel, referred to as the Data Variables Panel 536 (in Data Variables Selection region of the user interface 512), pops up beside the Data Sources Panel 526 and contains an array of data objects or data variables objects 538, as shown in FIG. 5B. The array may reflect the arrangement of data sets (variables) stored in the data source. Here, the data objects 538 are referred to as “data variable objects” because, when this view of the user interface is active, the user is typically contemplating use of a data analysis tool and reviewing the data source for data sets to be used as input data variables to the tool function. In an important aspect of this user interface 512, each data variables object 538 presents, in an efficient and concise fashion, multiple properties of the underlying data set, which the user can review. In this respect, the object 538 is described as having visual attributes that correspond to properties of the underlying data set. As previously shown in FIG. 3D, the data variables object 538 is a tile that serves as the platform for multiple descriptive elements. First, the tile showcases a hexagon icon with a graphical symbol signifying a data type—numeric, date and time, or text. Secondly, the tile includes text providing a name description, data count, and data type of the underlying data set. So, with this view of the Panel 536, the user may be able to eliminate data sets from consideration or determine the viability of a data set for tool implementation and study. For example, if the user expects a small file of numeric data, objects referring to TimePeriod data or a Subgroup file with a hundred items may be readily eliminated from further consideration.

In any event, positioning the pointer about (and hovering over) a data variables object 538 automatically displays a statistical summary attributable to the underlying data set. Specifically, this user action initiates a pop-up object 540—a window summarizing the underlying data set, as now shown in FIG. 5D. For example, enabling the third data variable object 538 automatically displays a histogram 542 and statistical information pertaining to the selected data set. In this window 540, the statistical information includes maximum, minimum, mean, standard deviation, and an Anderson-Darling p value. In alternative embodiments, other properties of the data set may be shown in this view. In some applications, only summaries and information particularly relevant to a selected tool function, for example, may be revealed. The Data Variables Panel 536 provides, therefore, additional and preliminary visual clues on the underlying data sets. It should be noted as well that the additional information provided would not be readily available to the user on review of the raw data. As mentioned previously, providing such information to the user facilitates tool selection and comparisons, among other things. In some applications, the summary information may suggest to the user what tool function may be helpful or simply prompt the user to select a tool function to analyze particular characteristics summarized or suggested by the summary information. For example, the degree of normality of a data distribution reflected in a histogram or the AD p-value may indicate to an experienced user the applicability of a hypothesis testing tool or other tool functions. Other summary information may suggest to another experienced user the need for certain data analysis to possibly reveal important information embedded in the data or to modify or transform the data to a format that is more informative to the user.

Generating a Study: Box Plots

FIGS. 6A-6G depict various states of a graphical user interface 612 through which a method of data analysis is performed, at least in part (wherein like reference numerals are used to indicate like items). In this example, the user intends to generate a box plot for a certain data set. Referring first to FIG. 6A, the user navigates the Tools menu bar 518 and clicks on the Measure tab 542, which activates pull-down Tools Bar menu 520 containing the Box Plot Tool. In this embodiment, the Box Plot Tool function graphs the distribution of numeric variable while also displaying summary statistics. To activate, the user either clicks on the button for the tool or simply drags and drops the button in the workspace 514. In either case, a new study object 650 representing a data analysis event employing the box plot tool function appears in the workspace 514. See FIG. 6B.

An icon for the new study object 650 contains a central hexagon (a Box Plot icon 652) laid over a circular background 658. The circular background 658 is preferably of a light shade and has a dashed circumference, which indicates an incomplete or pending status of the study object 650. Furthermore, the study object 650 includes at least one data variable field object 654 signifying a data variables input requirement. This object 654 is presented on the outside of the tool object 652, and over the dashed perimeter of the circular background 658. The data variables field object 654 is distinguishable from the tool object 652 not only by its “data variables” label, but also by color. In this embodiment, it is of a color much lighter than the dark tone of the tool object 652. The hexagon-shaped data object 654 is a data variable field that is configured to draw and accept another hexagon object (e.g., one being passed in proximity). Notably, the data variable field 654 is of the same hexagon shape as the movable hexagon icon of data objects 538 in Data Variables Object Panel 536.

When a control pointer is hovered over the new study object 650, a tool tip box 656 pops up next to the study object 650. In this embodiment, the tool tip box 650 informs the user of the data type appropriate for the input into the data variable field, which in the illustrated example calls for a numeric variable.

As shown in FIG. 6B, a corresponding study object 660 is automatically established in the Studies Panel 522 when the Box Plot tool is selected and brought to the workspace 514 (i.e., when new study object 650 is established). The saved study object 660 in the Studies Panel 522 includes a hexagon honeycomb icon and text identifying the type of analysis (“box plot”) performed and date or elapsed time since the study was established. As with many of the object elements employed by the user interface of the disclosure, the hexagon honeycomb object 660 physically matches other associated object elements—in this case, the new study object 650. As mentioned previously, the Study may be recreated by simply dragging and dropping the saved study object 660 in the workspace 514. The Study can also be modified once placed active in the workspace 514.

With some information on the properties of the data variables (i.e., numeric type) required for Tool function input, the user navigates the pointer to a data source object 528, thereby enabling it and prompting the associated Data Variables Object Panel 536. The user looks to and reviews this Panel 536 to match possible data variables to the active Study. In the user interface environment, this means matching one of the data variable objects (hexagon) 538 from the Panel 536 with the data variables field object (hexagon) 654 in the study object 650. Among other things, the user looks for a data variables object 538 that signifies a numeric type. The user may look, as well, to the name of the data set. The content associated with a data variables object should eliminate some candidate data objects for consideration. Here, the user enables the “Vendor Data 2” data variables object 638, which type is numeric, and activates its Summary Window 540. See FIG. 6D. After review, the user drags the data variables object 638 toward study object 650 and near data variables field 654 (see FIG. 6E), where upon release it is automatically pulled into and contacts the data variables field object 654. The data variables object 638 is said to have been moved substantially into the data variables field object 654, and on release, is attached to the tool object 652. Data variables object 638 and new study object 650 (and alternatively, tool object 652) are said to be engaged at this point. Notably, the dash circle background 658 disappears which, for the associated single variable Tool function, signifies completion of the Study formula.

More importantly, with the engagement of study object 650 by data variables object 638, the Tool function is simultaneously implemented to perform data analysis on the target data. As a result, output window 662 is generated next to tool object 652 and, in one respect, made a part of study object 650. Window 662 includes, of course, a box plot 664 of the target data (data set underlying data variables object 638) as well as box 666 which contains summary statistical information on the data set. See FIG. 6F.

The study object 650 may be modified on the user interface 512 in any number ways, thereby modifying the Study. In the illustrated example, the study objet 650 may be appended with additional data variables objects 638. With each appendage, the Tool function is initiated for the additional target data and the box plot 664 and summary table 666 are appropriately modified. The study object 650 is configured such that each of the additional data variables objects 638 may be attached to other data variables objects 638 or replace and dislodge other data objects 638. When multiple data variables objects 638 are used, these are positioned contiguously to the study object 650. The order of representations on the box plot 664 and summary table 666 will automatically rearrange to match the relative positions of the data variables objects to new study object 650. Thus, data or output in window 664 may be manipulated by simply positioning the corresponding data variables objects 638. In FIG. 6G, two more data sets have been selected for data analysis by attaching their corresponding data variables objects 638 on study object 650. Almost intuitively, the multiple data variables objects 538 attach together and are of the same color, signifying their common data type and input to the tool function. The objects 638 are described as being in contiguous positional relationships, in respect to one another and with tool object 652. In the alternative, replacing a previously integrated data variables field object with another data variables field object automatically updates and replaces the analytical results. It should be noted that at the end of the user's data analysis exercise, the new study object 650 is transformed to a cluster of dynamic objects—or aggregates of information associated with a study event(s). The new study object 650 and all of its associated objects and information may be accessible and reproducible by the user or a different user in the future. The study object of the present disclosure presents, therefore, a cluster of objects that provided a durable visual context of historical, present, and ongoing analyses.

Quick View Capability Analysis

FIGS. 7A-7F depict another user interface environments suitable for a data analytical software application and incorporating various advantageous user interface elements and techniques, according to the disclosure. The user interface 512 shown illustrates again the object-oriented approach followed in the system and method. In particular, these examples illustrate the advantage gained in utilizing user interface objects with visual attributes to represent data and as a vehicle to link or translate data between objects or from one location to another in a workspace 514 of the user interface 512, and also at different points in time for a project or different users.

In this example, the user evaluates a process improvement effort by conducting a process capability analysis. The user finds and enables the Measure phase tab 542 on the Task Menu 518. From the pull-down Tool Bar 520, the user selects a Quick View Capability Analysis Tool. As readily understood in the art, this type of analysis is used to evaluate whether a process is statistically able to meet output requirements. The analysis typically involves a set of calculations on target data. As in the previous example, presentation of the data analysis tool in the workspace 514 establishes a new Study without any data file or data objects being associated with the Study. A new study object 750 appears in the workspace 514, with text attributes that indicate a numeric data variables field and a numeric subgroup field. Viewing the study object 750 in conjunction with the Data Variables Panel 536 to the left gives the user directions on completing the desired data analysis, particularly in selecting data variables for entry into the data variables field object 754.

The study object 750 is provided in the familiar honeycomb icon that appears to be built by complementary hexagon objects on a light colored circular background 758. The objects are differentiated by name, color, and position. Appropriately, the tool or operation object 752 is positioned at the center or hub of the study object 750. The tool object 752 is also further distinguished by a wrench icon. The light circular background 750 on which the objects are situated has a broken or dashed perimeter (dashed) to convey incompletion. By prompting the field objects, the user gets a useful tip on selecting data variables. The study object 750 suggests to the user what data variable objects may match the data variables field 754 and subgroup variables objects 766 in the study objects. As shown in FIG. 7B, the user selects and drags a data variables object 738 from the Data Variables Panel 536 toward the data variables field object 754.

On engagement of data variables object 738 with study object 750, a window 770 associated with the Study and with the study object 750 is outputted. The window 770 functions as a workpad that provides the data analysis tools available. The workpad 770 also uses color coordination to show which object is associated with the displayed tools FIG. 7D provides results in another window 772 using a first data variables object, which include charts and data summaries. It should be noted also that the output will automatically change when the first data variable FIG. 7D also shows that the results of the study are automatically changed when the data variables object 754 entered is replaced by another.

Each of FIGS. 7E and 7F illustrates yet another advantageous feature of the user interface 714. In FIG. 7E, study object 750 is modified to include a window 780 in which text notes may be entered for the Study. The text notes window 780 becomes yet another object piece in the cluster of objects (and information) that is (and associated with) the study object 750. As with the other objects, the text notes window 760 is reproducible on enablement of a corresponding stored study object 700. The text notes window 780 provides user-added or user-associated information that may be particularly helpful to a second user working with or after the first user.

In FIG. 7F, the study object 750 is modified to include a window 782 that contains a link to a file or other artifact identified to the study that then becomes associated with the Study. Window 782, and the artifact within window 782, is yet another object element added (by the user in this case) to the cluster of objects that make up the study object 750. In some applications, the file may be a report with detailed interpretations or conclusions applicable to the data analysis output or the project. The file may be intended for the user's future use or use by another user or third party. In further embodiments, the uploaded or uploadable artifacts can be image files, videos, or documents, among other things. Such user-added information provides further context and helps users comprehend the practical significance of any conclusions reached from the study output—especially in a shared environment where multiple users may participate in the analysis and contribute to the critical thinking As again shown in these examples, the visual object-oriented approach facilitates communication and transitions among groups who are working on a project, sharing data, and/or jointly performing the analytical work.

The foregoing description of exemplary embodiments is not intended to limit or restrict the scope or applicability of described systems, methods, and user interfaces. For example, the description focused on a particular type of software application, but such descriptions were provided for illustration and to give context to the described elements, methods, and procedures. It will be apparent to one skilled in the relevant art that many of these elements, methods, and procedures will also be applicable when integrated with or used in other environments. Specifically, many of the user interface features and techniques described in respect to FIGS. 3-7 may be used in conjunction with many other types of software applications, analytical methods, or computing environments.

What is claimed is:

1. A computer-implemented method of initiating a data analysis function on a graphical user interface of a computer display, said computer-implemented method comprising:
presenting a graphical user interface on a computer display of a computing apparatus having a controller, the graphical user interface containing a plurality of graphical objects controllable by the controller, including a tool object associated with a data analysis function and a data object selection region containing at least one data object associated with at least one stored data set;
selecting a tool object associated with a data analysis function to establish a corresponding study object on the user interface;
enabling the at least one data object associated with the at least one stored data set; and
engaging the study object with the at least one data object on the user interface to initiate the data analysis function, whereby the at least one stored data set are input variables to the data analysis function and a graphical element is displayed on the user interface as output to the initiated data analysis function.

2. The method of claim 1, wherein engaging the study object includes moving at least one of the data object and study object from one location on the user interface to another location contacting the other of the data object and study object.

3. The method of claim 2, wherein the study object includes a data variables field having a shape that matches a shape of the data object, such that the data object is moved substantially into the data variables field to engage the study object.

4. The method of claim 1, wherein engaging the at least one data object and the study object to initiate the data analysis function generates an output incorporated with the study object, the output including the graphical element.

5. The method of claim 4, further comprising:
closing the study object thereby saving a corresponding study object; and
opening the corresponding study object to recreate the first study object on the user interface including the output and the at least one data object in the data variables field.

6. The method of claim 4, further comprising enabling a second data object associated with a second stored data set and moving the second data object into contiguous positional relationship with the first data object, thereby initiating a data analysis function with the first stored data set and the second stored data set as input.

7. The method of claim 1, further comprising:
prior to enabling the at least one data object, enabling a data source panel providing the data object selection region to present a plurality of data objects each associated with a stored data set including said at least one data object.

8. The method of claim 7, wherein presenting the plurality of data objects includes, for each data object, providing at least one visual attribute corresponding to a property of the associated data set.

9. The method of claim 8, wherein providing at least one visual attribute includes indicating a data set count and a data type.

10. The method of claim 8, wherein providing at least one visual attribute includes presenting a movable icon substantially matching a data variables field icon of the study object, the movable icon being substantially movable into the data variables field icon to engage the study object.

11. The method of claim 8, wherein enabling the at least one data object further displays a window containing properties of the data set, including output of data analysis on the associated data set.

12. A computing system, comprising:
one or more processors;
a display;
a memory coupled to the one or more processors, wherein the memory stores program instructions executable by the one or more processors to display a graphical user interface on the display, the graphical user interface including:
a data object selection region containing at least one user interface data object associated with a stored data set, the at least one data object displaying visual attributes corresponding to properties of the data set, including an attribute corresponding to data type.

13. The computing system of claim 12, wherein the visual attributes include a first attribute reflective of data type and a second attribute containing a graphical display derived from the associated data set.

14. The computing system of claim 12, wherein the data object further includes a window containing properties of the data set, the window being displayable in response to enablement of the data object.

15. The computing system of claim 12, wherein the data object selection region contains a plurality of said data objects, the data objects each having visual attributes corresponding to properties of an associated data set.

16. The computing system of claim 12, wherein the user interface further includes a tool object associated with a data analysis function, a study object, and a data variables field, and wherein the study object is displayed on the user interface in response to enablement of the tool object, the study object including the data variables field; and
wherein the data object is movable to the data variables field to initiate the data analysis function with the associated data set being input thereto.

17. The computing system of claim 16, wherein the data object and the data variables field have the same geometric shape.

18. The computer system of claim 12, wherein the user interface further includes a tool menu containing a plurality of tool objects each associated with a data analysis function, a data set panel providing the data selection region and containing a plurality of said data objects each associated with a stored data set, and a work space adjacent the tool menu and the data source panel, each tool object being movable to the workspace to present a study object thereon, the study object having a data variables field and a tool object associated with one of the tool objects in the tool menu, and wherein one or more of the data objects is movable into the data variables field to initiate a data analysis function associated with said one of the tool objects contained in the tool menu.

19. The computer system of claim 18, wherein the user interface further includes a studies panel containing one or more stored study objects each associated with a stored study defined by a tool object, at least one data object, and output of a data analysis function associated with the tool object and initiated with data set associated with the data object as input.

20. A computing system, comprising:
one or more processors;
a display;
a memory coupled to the one or more processors, wherein the memory stores program instructions executable by the one or more processors to display a graphical user interface on the display, the graphical user interface including:
at least one user interface data object associated with a stored data set; and
at least one user interface study object associated with a data analysis function, the data object being movable into engagement with the study object to initiate the data analysis function with the stored data set as input.

21. The computing system of claim 20, wherein the study object includes a tool object associated with the data analysis function and a data variables field substantially corresponding to the data object and configured to receive the data object therein to engage the data object with the study object.

22. The computing system of claim 21, wherein the data object has a shape hat corresponds with a shape of the data variables field of the study object.

23. The computing system of claim 21, wherein the study object includes an output window displaying an output of the data analysis function.

24. The computing system of claim 21, wherein the data object includes visual attributes corresponding to properties of the data set, including an attribute corresponding to data type, and wherein the study object includes visual attributes corresponding to properties of input data variables to the data analysis function.

25. A non-transitory computer-accessible storage medium storing program instructions computer-executable to implement a graphical user interface for presentation on a computer display, wherein:
the graphical user interface includes at least one user interface data object associated with a stored data set, the at least one data object displaying visual attributes corresponding to properties of the data set; and
wherein the at least one data object is movable from the data object selection region to an analysis region to initiate input of the data set into a data analysis function.

26. The non-transitory computer-accessible storage medium of claim 25, wherein the graphical user interface further includes a tool selection region containing a plurality of tool objects each associated with a data analysis function, the tool object being responsive to enablement to establish a study object in the analysis region of the user interface, including a data variables field configured to receive the data object and initiate the data analysis function with the stored data set as input.

27. The non-transitory computer-accessible storage medium of claim 26, wherein the analysis region is at least a portion of a workspace of the user interface, the user interface further including a stored study objects panel containing a plurality of stored study objects including a stored study object corresponding to the study object established in the analysis region, the corresponding stored study objects being configured to reproduce the established study object in the workspace in response to enablement.

28. The non-transitory computer-accessible storage medium of claim 25, wherein the visual attributes include a first attribute reflective of data type and a second attribute containing an analysis chart derived from the associated data set.

29. The non-transitory computer-accessible storage medium of claim 28, wherein the data object further includes a window containing properties of the data set, the window being displayable in response to enablement of the data object.

30. The non-transitory computer-accessible storage medium of claim 25, wherein the user interface further includes a tool menu containing a plurality of tool objects each associated with a data analysis function, a data set panel containing the data selection region and a plurality of said data objects each associated with a stored data set, and a work space adjacent the tool menu and the data set panel, each tool object being movable to the workspace to present a study object thereon including the tool object, the study object having a data variables field and wherein one or more of the data objects is movable into the data variables field to initiate a data analysis function associated with the tool object.

31. The non-transitory program of claim 30, wherein the study object includes the tool object associated with the data analysis function, the data object engaged with the data variables field, a second data object attached to the first data object and engaged with the study object to input data associated therewith into the data analysis function, and output of the data analysis function initiated with the first data set and the second data set as input variables.

32. The non-transitory computer-accessible storage medium of claim 31, wherein the study object further includes a window containing user-added text information.

33. A computer-implemented method of initiating a data analysis function on a graphical user interface of a computer display, said computer-implemented method comprising:
presenting a graphical user interface on a computer display of a computing apparatus, the graphical user interface containing a workspace and a plurality of graphical objects, including a tool object associated with a data analysis function and at least one data object associated with at least one stored data set;
enabling the tool object to establish a study object in the workspace, the study object including at least one data variables field and the tool object;
enabling the at least one data object associated with at least one stored data set, thereby displaying a container window indicating properties of the at least one data set on the user interface;
engaging the study object with the at least one data object on the user interface by attaching the at least one data object to the data variables field thereby initiating the data analysis function, whereby the at least one stored data set is inputted as variables to the data analysis function and whereby an output to the data analysis function is displayed in the workspace; and
after disabling the study object to remove the study object from the workspace, enabling the study object to reproduce the study object on the workspace including the output.
